(19) United States
(12) Patent Application Publication
(10) Pub. No.: US 2026/0296973 A1
(43) Pub. Date: Oct. 1, 2026

(54) HIGHLY ABSORBENT SPONGE CONCRETE

(71) Applicant: AMRIZE TECHNOLOGY SWITZERLAND LLC, Zug (CH)

(72) Inventors: Isabelle Javierre, Saint Quentin Fallavier (FR); Isabelle Dubois-Brugger, Saint Quentin Fallavier (FR); Fabrice Toussaint, Saint Quentin Fallavier (FR); Anthony Peuchlestrade, Saint Quentin Fallavier (FR)

(73) Assignee: AMRIZE TECHNOLOGY SWITZERLAND LLC, Zug (CH)

(21) Appl. No.: 19/480,633

(22) PCT Filed: May 2, 2024
(86) PCT No.: PCT/EP2024/062149

§ 371 Date: Oct. 31, 2025

(30) Foreign Application Priority Data
May 3, 2023 (EP) 23315153.9

(51) Int. Cl. C04B 28/06; C04B 18/02; C04B 22/00; C04B 24/38; C04B 38/00; C04B 38/08; C04B 103/10; C04B 103/32; C04B 103/44; C04B 111/40

(52) U.S. Cl. CPC C04B 28/065; C04B 18/02; C04B 22/0093; C04B 24/383; C04B 38/0058; C04B 38/0074; C04B 38/08; C04B 2103/10; C04B 2103/32; C04B 2103/44; C04B 2111/40

(57) ABSTRACT

A highly absorbent concrete material including a porous concrete with an open porosity ranging from 15% to 40%, preferably from 25 to 35%, said porous concrete including interconnected pores at least partially filled with an absorbent mineral composition, said absorbent mineral composition including 90 wt.-% or more, preferably 95 wt.-% or more, relative to the total weight of the absorbent mineral composition, of: cement, and a viscosity modifying agent, wherein the absorption capacity and/or the capillarity absorption of the absorbent mineral composition is typically of 50 wt.-% or more, relative to the total weight of the absorbent mineral composition. A process for preparing the absorbent concrete material and uses thereof.

### FIELD OF THE INVENTION

The invention relates to a “sponge concrete” (absorbent concrete material) with high water absorptive and evapotranspiration capacity, and the process for preparing said “sponge concrete”. The absorbent concrete material is useful as construction material, in particular with the view of helping manage local temperature during heat episodes in an urban environment. Further, the absorbent concrete material is useful as depolluting material.

### BACKGROUND OF THE INVENTION

Evapotranspiration is a combination of evaporation and transpiration, measured in order to better understand crop water requirements, irrigation scheduling, and watershed management. The two key components of evapotranspiration are:
Evaporation: the movement of water directly to the air from sources such as the soil and water bodies. It can be affected by factors including heat, humidity, and wind speed,
Transpiration: the movement of water from root systems, through a plant, and exit into the air as water vapour. This exit occurs through stomata in the plant. Rate of transpiration can be influenced by factors including plant type, soil type, weather conditions and water content, and also cultivation practices.

Globally, it is estimated that on average between three-fifths and three-quarters of land precipitation is returned to the atmosphere via evapotranspiration.

The evapotranspiration cycle is primarily influenced by climatic factors:
the amount of water present;
the amount of energy present in the air and soil (e.g. heat); and
the ability of the atmosphere to take up water.

Secondary factors include in particular vegetation and humidity factors, soil permeability, or urban geometry.

Reduction of evapotranspiration in urban areas, in particular through extensive concreting which “seals” the soil, is known to contribute to higher temperatures during heat waves. Indeed, evapotranspiration allows to provide a cooling which can be quantified by considering the latent heat of water which is 2474 KJ/Kg at 20° C. As an example, the evaporation of 1 mm/h·m² (1 liter/m²) would give a cooling power of 2474×1000/3600=687 Watt/m².

City greening policies involving tree planting is important, but usually not efficient in the short term.

There is thus a need for new materials able to increase water absorption, in particular in urban areas.

The present invention thus aims to provide an absorbent concrete material with improved absorption capacity and capillarity as well as evapotranspiration capacity, suitable for use as construction material, or in particular for managing local temperature during heat episodes in an urban environment. Further the absorbent material is suitable to be used as depolluting material for removing, at least in part, from the atmosphere gases and volatile compounds.

### SUMMARY OF THE INVENTION

In first aspect, the invention concerns an absorbent concrete material comprising a porous concrete with an open porosity ranging from 15% to 40%, preferably from 25 to 35%, expressed as a volume percentage of the porous concrete, said porous concrete comprising interconnected pores at least partially filled with an absorbent mineral composition, said absorbent mineral composition comprising 90 wt.-% or more, preferably 95 wt.-% or more, relative to the total weight of the absorbent mineral composition (in the dry state), of:
cement, and
a viscosity modifying agent.

Advantageously, the absorption capacity (measured using the method described below) and/or the capillarity absorption (measured using the method described below) of the absorbent concrete material is typically of 15 wt.-% or more, relative to the total weight of the absorbent mineral composition (in the dry state).

In another aspect, the invention relates to a use of the absorbent concrete material to improve evapotranspiration of construction materials or as a mineral cooling material.

The absorbent concrete material of the invention provides the following advantages:
High water retention capability, and high capillarity absorption capacity, allowing for use as passive cooler with evapotranspiration capacities.
Mechanical performance comparable to the original pervious concrete, not filled by the absorbent mineral composition.
Draining capabilities allowing continuous drainage after saturation.

This allows the absorbent concrete material of the invention to help managing local temperature during heat episodes in an urban environment, in particular by avoiding the formation of “heat islands”.

In another aspect, the invention concerns a cement slurry comprising:
cement,
water, and
a viscosity modifying agent,
   with a water/cement mass ratio (hereinafter W/C) ranging from 2 to 5, preferentially 2 to 4. The invention further concerns the absorbent mineral composition obtained upon setting and optionally curing of said slurry.

In another aspect, the invention relates to a process for preparing cement slurry:
cement,
water, and
a viscosity modifying agent,
   with a water/cement mass ratio ranging from 2 to 5, preferentially 2 to 4, said process comprising:
a) Providing a cement or a cement premix,
b) mixing a viscosity modifying agent in water so as to obtain a solution with a yield stress value typically ranging from 0.1 to 1.0 Pa,
c) Adding the cement or cement premix of step a) to the solution of step b) so as to obtain a W/C ranging from 2 to 5, preferentially 2 to 4, and blending to obtain the cement slurry.
   or
a′) Providing a cement or a cement premix including a viscosity modifying agent,
b′) Adding the cement or cement premix including a viscosity modifying agent of step a′) to water so as to obtain a W/C ranging from 2 to 5, preferentially 2 to 4, and blending to obtain the cement slurry.

In another aspect, the invention relates to a process for preparing an absorbent concrete material, comprising:
a) Providing a porous concrete with an open porosity of 15% or more expressed as a volume percentage of the porous concrete, said porous concrete comprising interconnected pores,
b) Providing an absorbent cement slurry according to the process of the invention, and
c) Casting the absorbent cement slurry within the porous concrete so as to fill at least partially the pores with the cement slurry, and letting it set.

### Definitions

Total mass (weight) of a material/composition: As used herein, the “total mass of a material/composition” or “total weight of a material/composition” is understood as the total mass (or weight) of the material/composition in the dry state, i.e. the total mass (or weight) of the dry matter of the material/composition. Indeed, the water content absorbed in the absorbent mineral composition or absorbent concrete material may vary depending on a number of factors, including climatic conditions (for instance pluviometry, temperature, humidity, etc.). The material/composition is in the dry state when its mass (or weight) remains constant. The total mass (or weight) of the material/composition can be determined by drying the composition at 40° C. until its mass (or weight) remains constant, i.e. until the mass (or weight) difference between two weighings measured 24 hours apart, is of 1.0% or less.

Wt %: the wt % of a composition is calculated relative to the total weight of the composition, as defined above.

Mass %: the mass % of a composition is calculated relative to the total mass of the composition, as defined above.

Cement: The cement comprises Portland clinker and a source of calcium sulfate. The cement is preferably as defined in the standard NF-EN-197-1 of April 2012, or in the standard NF EN 197-5 published in May 2021. The cements defined in these standards are grouped in 6 different families: CEM I, CEM II, CEM III, CEM IV, CEM V and CEM VI. The cement can also be a CEM I, CEM II, CEM III, CEM IV, CEM V or a CEM VI to which mineral components are further added in a second preparation step. The cement may be any mineral binder that comprises Portland clinker optionally mixed with one or several mineral components as defined below. The cement may optionally further contain 10 wt.-% or less of a calcium aluminate cement or a calcium sulfoaluminate cement if shorter setting times and higher early age strength development are for example required.

Calcium sulphate: Calcium sulphate used according to the present invention includes gypsum (calcium sulphate dihydrate, CaSO₄·2H₂O), hemi-hydrate (CaSO₄·½H₂O), anhydrite (anhydrous calcium sulphate, CaSO₄) or a mixture thereof. Calcium sulphate produced as a by-product of certain industrial processes may also be used. Preferably, the calcium sulphate content ranges from 0% to 5% by weight of the cement.

Mineral component: the mineral component may designate slag (for example, as defined in the European NF EN 197-1 Standard of April 2012, paragraph 5.2.2), pozzolanic materials (for example as defined in the European NF EN 197-1 Standard of April 2012, paragraph 5.2.3), fly ash (for example, as described in the European NF EN 197-1 Standard of April 2012, paragraph 5.2.4), calcined schists (for example, as described in the European NF EN 197-1 Standard of April 2012, paragraph 5.2.5), material containing calcium carbonate, for example limestone (for example, as defined in the European NF EN 197-1 Standard paragraph 5.2.6), limestone components (for example, as defined in the “Concrete” NF P 18-508 Standard), silica fume (for example, as defined in the European NF EN 197-1 Standard of April 2012, paragraph 5.2.7), siliceous components (for example, as defined in the “Concrete” NF P 18-509 Standard), metakaolin or mixtures thereof. The mineral component may also be ground construction demolition waste.

Examples of siliceous components are ground glass, solid or hollow glass beads, glass granules, expanded glass powder.

Cement slurry: The expression “cement slurry” designates a mixture comprising water and cement. That cement slurry may also comprise additional components, as disclosed below.

The terms “slurry of cement” and “cement slurry” have the same meaning and will be used interchangeably.

Essentially free of: As used herein, a material is “essentially free of” a particular component when the component is present in a very low content, usually 5% by weight or less, compared to the total weight of the material, more especially below 1% by weight. For instance, a cement is essentially free of sand when sand is present in the cement in an amount of less than 5 wt.-% or preferably 1 wt.-% of the total weight of cement.

Viscosity-modifying agent (or VMA): Viscosity modifying agents are able to modify yield stress, viscosity, and thixotropy of the cement slurry. VMAs are also known in the art as viscosity modifying admixtures, viscosity enhancing agents (VEAs), or stabilizing agents (SAs).

VMAs are usually biobased polymers, and include cellulose ethers, natural gums (xanthan, wellan, diutan) and starch and combinations thereof (see https://doi.org/10.1016/j.cemconres.2021.106646). For example, Mecellose® HiEND 2001 by LOTTE Fine Chemical is a suitable VMA for the present invention.

Absorption Capacity: As used herein, the “absorption capacity” is the mass % of water that an absorbent mineral composition is able to absorb when fully immersed under water for 1 hour.

It is measured using the protocol disclosed in the method part.

Capillarity Absorption: As used herein, the “capillarity absorption” is the mass % of water that an absorbent mineral composition is able to absorb by 10% of its volume is immersed under water for 1 hour.

It is measured using the protocol disclosed in the method part.

Yield stress: The yield strength or yield stress is a material property and is the shear stress corresponding to the yield point at which the material begins to deform plastically. The yield strength is often used to determine the maximum allowable load in a mechanical component, since it represents the upper limit to forces that can be applied without producing permanent deformation.

Open Porosity: The open porosity refers to the ratio of the fluid volume occupied by the continuous fluid phase (air in the present invention in the dry state) to the total volume of porous material. The open porosity differs from the “closed porosity” or “internal porosity”, which is the ratio of the volume of void space within the material that is not accessible from the exterior to the bulk volume. The open porosity is made of a network of connected pores.

Open porosity may be measured by a variety of methods, preferably the mercury intrusion method as disclosed in the method part. Open porosity is expressed as a volume percentage of the porous material.

NOx: As used herein, “NOx” is shorthand for nitric oxide (NO) and nitrogen dioxide (NO2), the nitrogen oxides that are most relevant for air pollution. These gases contribute to the formation of smog and acid rain, as well as affecting tropospheric ozone.

### DETAILED DESCRIPTION OF EMBODIMENTS OF THE INVENTION

### 1. Absorbent Mineral Composition and Absorbent Cement Slurry

The absorbent mineral composition is obtained after setting and optionally curing an absorbent cement slurry.

The absorbent cement slurry comprises or essentially consists of:
cement,
water, and
a viscosity-modifying agent,
   with a water/cement mass ratio (hereinafter W/C) ranging from 2 to 5, preferentially 2 to 4., and preferably with a viscosity-modifying agent/cement mass ratio ranging from 0.1 and 0.8.

In a particular embodiment, the absorbent cement slurry comprises 1% or less of sand and/or aggregates. Preferably, the cement slurry is essentially free of sand or aggregates.

Advantageously, the cement slurry is devoid of any expansion agent.

Advantageously, the cement slurry has a yield stress ranging from 0.1 to 1.0 Pa.

Preferably, the cement used for the absorbent mineral composition has an initial setting time ranging from 80 to 150 minutes, and a final setting time ranging from 150 to 250 minutes at room temperature, also when additional admixtures, including accelerators, are added.

### Cement

The cement has the definition provided above.

The cement as used in the invention may be any type of cement comprising Portland clinker, whatever its chemical composition is, and in particular whatever its alkaline content.

Therefore, one of the advantages of the invention is not having to select a specific type of cement. Advantageously, the cement used in the invention is selected from the cements readily available on the market.

Cements that are less or not suitable for the present invention are calcium aluminate cements and their mixtures used alone. Calcium aluminate cements are cements generally comprising a mineral phase C4A3$, CA, C12A7, C3A or C11A7CaF2 or their mixtures, such as, e.g., Ciment Fondu® (a calcium aluminate-based hydraulic binder), alumina cements, sulfoaluminate cements and calcium aluminate cements according to the European NF EN 14647 Standard of December 2006. Such cements are characterized by an alumina (Al₂O₃) content equal or lower than 35 wt.-%. However, calcium aluminate cements, calcium sulfoaluminate cements, or mixtures thereof, may be used in small amounts if for example shorter setting times or increased early age strength is desired. Calcium aluminate cements, calcium sulfoaluminate cements, or mixtures thereof, may not exceed 10 wt.-% relative to the total weight of cement.

Accordingly, preferably, the cement of the invention has an alumina (Al₂O₃) content lower or equal to 35 wt.-%.

As mentioned above, the cement may comprise mineral components as defined above. Suitable mineral components are preferably selected from calcium carbonate, silica, ground glass, solid or hollow glass beads, glass granules, expanded glass powders, silica aerogels, silica fume, slags, ground sedimentary siliceous sands, fly ash, calcined clays, pozzolanic materials, concrete demolition waste, ground construction demolition waste or mixtures thereof.

The mineral components are preferably in the form of particles having a Dv90 less than or equal to 200 μm, and more preferably a Dv97 less than or equal to 200 μm. Particle size can be measured by laser granulometry using for example a Malvern MS2000.

In a particular embodiment, the cement slurry comprises between 15 wt. % and 50 wt.-%, preferably between 20 wt. % and 40 wt. %, of cement relative to the total weight of the cement slurry.

In a particular embodiment, the absorbent mineral composition comprises 85 wt.-% or more, preferably 90 wt.-% or more, of cement relative to the total weight of the absorbent mineral composition.

### Viscosity-Modifying Agent

The viscosity-modifying agent is as described herein. Preferably, the viscosity modifying agent is an amphiphilic bio-based polymer.

In a particular embodiment, the VMA is a polymer derived from cellulose. Even more preferably the VMA is a cellulosic ether, such as Methyl Cellulose, MethylHydroxyEthyl Cellulose, HydroxyPropylMethyl Cellulose or mixture thereof. In a preferred embodiment, the VMA comprises or consists of xanthan gum or a polymer derived from xanthan gum, such as diutan gum. Mixtures of polymer derived from cellulose and of xanthan gum or a polymer derived from xanthan gum can also be contemplated.

Diutan gum is a natural high-molecular-weight gum produced by carefully controlled aerobic fermentation. The repeating unit is composed of a six-sugar unit. More specifically, the backbone of the repeating unit comprises d-glucose, d-glucuronic acid, d-glucose, and I-rhamnose, and the side chain of two I-rhamnose units. Diutan gum is commercially available under CAS number 125005-87-0.

Preferably, the viscosity-modifying agent/cement mass ratio ranges from 0.1 to 0.8, preferentially from 0.1 to 0.5.

### Water

The W/C ratio ranges preferably from 2 to 5, preferentially 2 to 4.

### Additives

Optionally, the absorbent cement slurry further comprises up to 5% additives by weight relative to the weight of cement.

Advantageously, the additives are selected from the group consisting of:
a water reducer, such as a plasticizer or a superplasticizer, to avoid agglomeration during the preparation of the material,
an accelerator, to reduce the setting time of the slurry,
a super absorbent polymer, to improve the water retention and further improve the evapotranspiration phenomenon for example when the absorbent material is exposed to high temperatures or direct sunlight,
a pigment, in particular a light pigment, to increase the albedo phenomenon, and
mixtures thereof.

Advantageously, the absorbent mineral composition may further comprise a water reducer, such as a plasticizer or a superplasticizer. A water reducer makes it possible to reduce the amount of mixing water for a given workability by typically 10-15% by weight. Super-plasticizers are capable of reducing water contents of mixing water, for a given workability, by approximately 30% by weight.

By way of example of water reducers, mention may be made of lignosulphonates or gluconates, hydroxycarboxylic acids, carbohydrates, and other specific organic compounds, for example glycerol, polyvinyl alcohol, sodium alumino-methyl-siliconate, sulfanilic acid and casein as described in the Concrete Admixtures Handbook, Properties Science and Technology, V.S. Ramachandran, Noyes Publications, 1984.

By way of example of a superplasticizer, the PCP super-plasticizers without an anti-foaming agent may be noted. The term “PCP” or “polyoxy polycarboxylate” is to be understood according to the present invention as a copolymer of acrylic acids or methacrylic acids and their esters of polyoxy ethylene (POE) and/or polyoxy propylene.

Preferably, the cement slurry comprises 0.05 to 0.5 wt.-%, more preferably 0.05 to 0.2 wt.-% of a water reducer, a plasticizer or a superplasticizer, percentage expressed by weight relative to the dry cement weight.

A water reducing agent contains a polymer and other chemicals and that enables the reduction by around 10 to 15% by weight the quantity of mixing water for a given slurry workability and rheology. As an example of water reducing agent may be cited lignosulphonates, hydroxycarboxylic acids, carbohydrates, and other specific organic compounds, such as for example glycerol, polyvinyl alcohol, sodium alumino-methyl siliconate, sulphanilic acid and casein (see Concrete Admixtures Handbook, Properties Science and Technology, V. S. Ramachandran, Noyes Publications, 1984).

Plasticizers are the first generation of water reducing agents. The amount of plasticizer generally depends on the cement reactivity. The lower its reactivity is, the lower amount of plasticizer is needed.

Superplasticizers belong to the new generation of water reducing agents and make it possible to reduce by around 30% by weight the quantity of mixing water for a given workability time. As an example of superplasticizer, it is possible to cite superplasticizers of PCP type that do not contain any antifoaming agent. The term “PCP” or “polycarboxylate polyoxide” is taken to mean according to the present invention a copolymer of acrylic acids or methacrylic acids; and their esters of poly(ethylene oxide) (POE). The amount of superplasticizer generally depends on the cement reactivity. The lower its reactivity is, the lower amount of superplasticizer is needed.

Preferably, the absorbent cement slurry comprises from 0.2 to 2.0%, more preferentially from 0.5 to 1.5%, by weight of a water reducing agent compared to the weight of cement.

When the water reducing agent is used in solution, the quantity is expressed in g of active ingredient per 1 L of solution.

Advantageously, the absorbent cement slurry may further comprise a superabsorbent polymer.

A superabsorbent polymer (SAP) is a water-absorbing hydrophilic homopolymer or copolymer that can absorb and retain extremely large amounts of a liquid relative to its own mass. Super-Absorbent Polymers are crosslinked in order to avoid dissolution. There are three main classes of SAPs: 1) Cross-linked polyacrylates and polyacrylamides, 2) Cellulose- or starch-acrylonitrile graft copolymers, and 3) Cross-linked maleic anhydride copolymers. Examples of SAP are sodium polyacrylate and potassium polyacrylate.

Preferably, the absorbent cement slurry comprises from 0.2 to 2.0%, more preferentially from 0.5 to 1.5%, by weight of a superabsorbent polymer compared to the weight of cement.

Advantageously, the absorbent cement slurry may further comprise an accelerator (or accelerating agent). The accelerator is typically as defined in the standard NF EN 934-2 of September 2002. Suitable accelerators may for example be selected from:
calcium salts, potassium salts and sodium salts wherein the anion may be nitrate, nitrite, chloride, formate, thiocyanate, sulphate, bromide, carbonate or mixtures thereof;
alkali silicates and aluminates, for example sodium silicate, potassium silicate, sodium aluminate, potassium aluminate or mixtures thereof.

Advantageously, it is present in an amount up to 0.5 to 3.0% by weight relative to the weight of cement.

In a particular embodiment, the absorbent cement slurry or mineral composition may further comprise a pigment, in particular a pigment having a light color. Pigments can be natural or synthetic, organic or inorganic. Synthetic pigments are more stable and color fast. Examples of pigments are iron oxide (black, bround, red, yellow of varying particle size and shape), chromium oxide (green), titanium dioxide (white), phthalocyanine (blue, green). Pigments are usually provided as fine powders. As used herein, a “light color” is understood as a color providing a high Albedo effect, i.e. a color which allows a high percentage of the light to be reflected by the colored surface. A Light color is preferably selected from white, yellow and grey shades.

White pigments, such as titanium oxide, are particularly preferred. Yellow pigments, such as yellow iron oxides, or grey pigments such as ground or precipitated limestone, may also be used.

### Others

Typically the absorbent mineral composition is not a cementitious foam.

In particular embodiments, the absorbent mineral composition and/or the cement slurry is essentially free of any expansion agent. Exemplary expansion agents are hydrogen peroxide, peroxomonosulphuric acid, peroxodisulfphuric acid, alkaline peroxides, alkaline earth peroxides, organic peroxide, particles of aluminium, or mixtures thereof. Other examples of expansion agents are calcium oxide, magnesium oxide, CSA or mixtures thereof.

In particular embodiments, the absorbent mineral composition and/or the cement slurry is essentially free of any foam stabilizing agents.

In particular embodiments, the absorbent mineral composition and/or the cement slurry is essentially free of polyvinyl alcohol, polyvinyl acetate or mixtures thereof.

Preferably, the addition of aggregates is not required. Aggregates include sand (whose particles generally have a minimum size (d min) greater than 0,063 mm and a maximum size (Dmax) of less than or equal to 2 or 4 mm), and gravel (whose particles generally have a minimum size (d min) greater than 4 mm).

Even more preferably, the absorbent cement slurry is essentially free of aggregates.

### PARTICULAR EMBODIMENTS

Advantageously, the cement slurry comprises or consist of:
cement,
0.01 to 0.5%, preferentially 0.1 and 0.4% by weight, of a viscosity modifying agent such as diutan gum, relative to the total weight of cement,
Up to 15%, preferably up to 5%, by weight of additives selected from the group consisting of a water reducer (such as a plasticizer or a superplasticizer), an accelerator, a superabsorbent polymer, a pigment (in particular a light pigment such as a white pigment), and mixtures thereof, relative to the total weight of cement,
Water,
   with a water/cement mass ratio (or W/C) ranging from 2 to 5, preferentially 2 to 4.

### Absorbent Mineral Composition

As such, the absorbent mineral composition has an absorption capacity or a capillarity absorption typically of 50 wt % or more, relative to the total weight of the absorbent mineral composition.

Advantageously, the absorbent mineral composition as such has an absorption capacity of 80 wt.-%, preferably of 85 wt.-% or more, even more preferably of 100 wt.-% or more, relative to the total weight of the absorbent mineral composition.

Usually, the absorption capacity and capillarity absorption of the absorbent mineral composition is of 200 wt.-% or less, relative to the total weight of the absorbent mineral composition.

The absorbent mineral composition is porous. Typically, the absorbent mineral composition has an open porosity of at least 50%, preferably ranging from 55% to 85% or more, expressed as a volume percentage of the absorbent mineral composition.

Advantageously, the absorbent mineral composition is very efficient as an acoustic (or phonic) insulator.

The absorbent mineral composition as such typically has a good compressive strength (especially compared with known mineral foams), typically ranging from 0.04 to 1.5 MPa after 28 days, preferably from 0.05 to 1.2 MPa after 28 days, more preferentially from 0.1 to 1.1 MPa after 28 days.

### 2. Process for Preparing the Absorbent Cement Slurry

Any conventional process for preparing a cement slurry is suitable to prepare the cement slurry of the invention.

However, preferably, the process to prepare the inventive cement slurry, which comprises or essentially consists of:
cement,
water, and
a viscosity modifying agent,
   with a water/cement mass ratio ranging from 2 to 5, preferably 2 to 4,
   said process comprises:
a) Providing a cement or a cement premix,
b) mixing a viscosity modifying agent in water so as to obtain an aqueous solution with a yield stress value typically ranging from 0.1 to 1.0 Pa,
c) Adding the cement or cement premix of step a) to the solution of step b) so as to obtain a W/C ranging from 2 to 5, and blending to obtain the cement slurry.

Alternatively, the process may comprise:
a′) Providing a cement or a cement premix including a viscosity modifying agent,
b′) Adding the cement or cement premix including a viscosity modifying agent of step a′) to water so as to obtain a W/C ranging from 2 to 5 (preferably 2 to 4), and blending to obtain the cement slurry.

The cement slurry may be blended and/or homogenized with water or the aqueous solution of step b) by any means to obtain a cement slurry. Preferably, step b′), or step (b) and/or step (c) is/are performed into a mixer, preferably equipped with deflocculating blades. Examples of suitable static mixers are disclosed in WO2022/122760 (p. 14, I.10-27).

Preferably, the rotating speed in step (b) ranges from 200 to 400 rpm, preferably of 300 rpm. Advantageously, the rotating speed in step (c) or (b′) ranges from 500 to 800 rpm, preferably it is of 600 rpm.

In step (c) or (b′), blending is preferably performed until the slurry is homogeneous, i.e. the presence of flocs is not visually detectable.

Typically, the VMA is added to the solution of step (b) as a powder.

Advantageously, step (a) consists in providing a cement premix. A cement premix is a mixture of cement with solid additives, such as accelerators, water reducing agents, SAP, pigments, or mixtures thereof. This step is highly beneficial as it enables to reduce the preparation time of the cement slurry, and also reduces the water demand of the cement slurry.

Advantageously, the additives comprise a water reducing agent and/or a SAP. The water reducing agent and/or a SAP may then be added to the aqueous solution of step (b). The solid content of water reducing agents is typically ranging from 15% to 45%.

The cement premix then is then typically a mixture of cement with solid additives selected from accelerators, pigments, and mixtures thereof.

Alternatively, the water reducing agent and/or SAP is in powder form. In this alternative, the cement premix is a mixture of cement with water reducing agents and/or SAPs, and optionally with solid additives selected from accelerators, pigments, and mixtures thereof.

The cement slurry is then obtained by adding the premix to water (when the premix comprises VMA) or to a solution of VMA in water. The solution can further comprise the water reducing agent when the latter is in liquid form.

Preferably, in step (b), the cement slurry is continuously stirred to avoid any deposition from occurring.

Step (c) or (b′) may be performed continuously or discontinuously, preferably continuously. Overall, the process may be a batch process or a continuous process. The person of skill in the art knows how to adapt the equipment in case of a continuous process.

The invention also relates to a cement slurry obtainable and/or obtained according to the process of the invention.

### 3. Absorbent Concrete Material

The invention concerns an absorbent concrete material comprising a porous concrete with an open porosity ranging from 15% to 40%, preferably from 25 to 35%, expressed as a volume percentage of the porous concrete, said porous concrete comprising interconnected pores at least partially filled with an absorbent mineral composition,
said absorbent mineral composition comprising 90 wt.-% or more, preferably 95 wt.-% or more, relative to the total weight of the absorbent mineral composition, of:
   cement, and
   a viscosity modifying agent,
wherein the absorption capacity (measured using the method described below) and/or the capillarity absorption (measured using the method described below) of the absorbent concrete material is typically of 15 wt.-% or more, relative to the total weight of the absorbent mineral composition.

### Absorbent Mineral Composition

The absorbent mineral composition is as defined herein above.

The pores may be partially or totally filled with the cement slurry. For instance, 50% (vol/vol) or more, 60% (vol/vol) or more, 70% (vol/vol) or more, or 80% (vol/vol) or more of the interconnected pores may be filled with the cement slurry.

Typically, the absorbent concrete material comprises between 15% and 30% (vol/vol) of absorbent mineral composition.

### Porous Concrete

Any type of porous concrete with an open porosity ranging from 15% to 40%, preferably from 25 to 35%, expressed as a volume percentage of the porous concrete, is suitable for use in the present invention.

Porous concretes and method to prepare same are known in the art.

Preferably, the porous concrete is a pervious concrete.

As used herein, a “pervious concrete”—also called “draining concrete”—is a concrete whose porosity, or volume of voids, is high enough for water to flow through the voids. A pervious concrete generally has few fine aggregates and a significant interconnection between the voids of the concrete. A pervious concrete element is generally prepared by mixing aggregates with a cement paste, filling a formwork or mold with the mixture and applying pressure to the upper surface of the concrete element to obtain a suitable filling of the formwork or mold as well as a flat top surface. The application of pressure to pervious concrete is generally referred to as concrete compaction and can be done manually or mechanically, for example by means of a shovel, roller, paver, etc. Pervious concretes are generally formulated so as to be only slightly compressible or even uncompressible, so as to preserve its high porosity even after compaction.

The person of skill in the art is familiar with pervious concrete formulations and process for preparing same, as described for instance in WO2012/001292.

Preferably, the open porosity of the porous concrete in the dried (hardened) state ranges from 15% to 35%, such as from 25% to 35% or from 30% to 35%, expressed as a volume percentage of the porous concrete.

Advantageously, the diameter of the aggregates in the porous concrete ranges from 4 mm to 14 mm.

Preferably, the porous concrete comprises less than 10% of aggregates with a diameter ranging from 0.063 mm to 2.0 mm.

Typically, the compressive strength of the porous concrete after 28 days ranges from 3 to 20 MPa.

Advantageously, in the dried (or hardened) state, the density of the porous or pervious concrete ranges from 1.5 to 1.9, preferably from 1.7 to 1.8, for aggregates whose density varies from 2.5 to 2.7. The density of the porous or pervious concrete may be even lower for lighter aggregates.

Typically, the porous concrete comprises, per cubic meter of fresh permeable concrete: from 80 to 200 liters, and preferably from 120 to 160 liters, of a mixture of a hydraulic binder and water, the ratio between the mass of water and the mass of hydraulic binder being from 0.25 to 0.4, said mixture having a flow threshold ranging from 20 to 100 Pa; and 450 to 700 liters of aggregates with a diameter of 2 mm to 32 mm.

The hydraulic binder comprises cement, and optionally additives and/or VMA.

More particularly, the porous concrete is as described in WO2012/001292, the content of which is incorporated herein by reference. In particular, the hydraulic binder may be as described in WO2012/001292, page 4 line 3 to page 5 line 9. It may in particular comprise a plasticizer as described page 5 line 10 to page 6 line 12. Other additives may be used such as defoamers (see page 6 lines 13-23), anti-efflorescence agents (see page 6 lines 24 to page 7 line 4), viscosity modifying agents (see page 7 lines 5-14), activating agents, accelerators and/or retarders (see page 7 lines 15-21). Exemplary compositions are also described from page 7 line 22 to page 8 line 12 and in the examples.

### Absorbent Concrete Material

Advantageously, the absorbent concrete material may further comprise activated carbon and/or biochar. The activated carbon and/or biochar may be comprised in the porous concrete and/or absorbent mineral composition of the absorbent concrete material.

By “active carbon” or “activated carbon” is meant a material in the form of a powder mainly constituted of carbonaceous matter with a micro porous structure.

As used herein, the term “biochar” designates a solid porous carbonaceous material which is produced by thermal decomposition of biomass.

The term “biochar” designates a solid porous carbonaceous material which is produced by thermal decomposition of biomass. Biochar is obtained by the thermal decomposition of biomass at a temperature ranging from 350 to 1200° C., preferably from 350 to 800° C., more preferably from 400 to 750° C. and even more preferably from 450° C. to 700° C. Advantageously, the heat treatment is a pyrolysis carried out at a temperature of above 550° C., and advantageously below 750° C. or 700° C. The pyrolysis is typically performed in an oxygen-reduced atmosphere. Oxygen-reduced atmosphere is understood as an atmosphere with oxygen content below 21%. Advantageously, pyrolysis is performed in an oxygen reduced atmosphere with less than 10% oxygen in the atmosphere.

Advantageously, the activated carbon and/or biochar is present in an amount ranging from 0.1-5 wt. %, relative to the weight of the cement in the absorbent concrete material.

The absorption capacity of the absorbent mineral composition and/or the capillarity absorption of the absorbent mineral composition is advantageously of 25% or more, preferably 30% or more.

The absorbent concrete material thus has a good evapotranspiration capacity, and is draining when the absorbent mineral composition is saturated. Typically, the absorbent concrete material has an evapotranspiration capacity as measured herein ranging from 2 to 9 mm/day, preferably from 3 to 8 mm/day.

Advantageously, the absorbent concrete material is also very efficient as an acoustic (or phonic) insulator.

The absorbent concrete material has typically a compressive strength of between 3 to 20 MPa after 28 days, preferably from 5 to 15 MPa after 28 days, more preferentially from 10 to 15 MPa after 28 days.

### 4. Preparation of the Absorbent Concrete Material

In another aspect, the invention relates to a process for preparing an absorbent concrete material, comprising:
a) Providing a porous concrete as described with an open porosity of 15% or more expressed as a volume percentage of the porous concrete, said porous concrete comprising interconnected pores,
b) Providing an absorbent cement slurry as described above, and
c) Casting or pouring the absorbent cement slurry within the porous concrete so as to fill at least partially the pores with the cement slurry, and
d) Curing it and/or leaving it to set.

The porous concrete of step (a) is typically in the dry (hardened) state.

The porous concrete of step (a) preferably has an open porosity ranging from 15% to 40%, even more preferably from 25 to 35%, expressed as a volume percentage of the porous concrete. The porous concrete of step (a) is as disclosed above. The porous concrete of step (a) may be a precast element or may be cast in place.

The absorbent cement slurry of step (b) may be prepared according to the process described herein in section 3. In particular, the absorbent cement slurry of step (b) may be pre-cast on the jobsite (for instance by installing a mixer on the jobsite), or produced at a production plant for precast elements.

Step (c) may further comprise a step of spreading the cement slurry on the porous concrete surface, for instance with a rake or a squeegee.

In step (c), the pores may be partially or totally filled with the cement slurry. For instance, 50% (vol/vol) or more, 60% (vol/vol) or more, 70% (vol/vol) or more, or 80% (vol/vol) or more of the interconnected pores may be filled with the cement slurry.

In a first embodiment, the porous concrete may be already in place within a construction. For instance, it may be a wall or floor of a building (such as a car park) or part of a pavement or urban furniture. In this first embodiment, step (c) preferably comprises pouring the absorbent cement slurry within (or on) the porous concrete, and step (d) comprises setting on site. In this first embodiment, step (b) advantageously comprises preparing the absorbent cement slurry on the jobsite. The cement slurry can be poured on the porous concrete immediately after setting occurs, or later.

In a second particular embodiment, the porous concrete may be a precast element to be installed such as a concrete slab, (part of) a pavement, a road, a road island such as a roundabout, or (part of) urban furniture such as banks and the like. In this second embodiment, step (c) preferably comprises casting the absorbent cement slurry within the porous concrete, and step (d) comprises curing and setting typically in a production plant for precast elements. In this second embodiment, the absorbent cement slurry of step (b) is preferably produced at a (or even more preferably at said) production plant for precast elements.

Advantageously, the process does not need any autoclave step, or thermal treatment step (for example at 60-80° C.) in order to obtain an absorbent mineral composition.

The curing of step (d) is preferably performed at room temperature comprised between 15° C. and 30° C. for a period of 1 to 7 days.

The setting (and optionally drying) time of step (d) may be reduced depending on the presence and amount of accelerator added to the cement premix.

The invention also relates to an absorbent concrete material obtainable and/or obtained by the process of the invention.

### 5. Uses

In another aspect, the invention relates to a use of the absorbent concrete material as an insulating material, or to improve evapotranspiration of construction elements. In the latter case, the absorbent mineral composition may be regarded as a “mineral cooling material”.

As an insulating material, the absorbent concrete material is relevant for construction materials. The building material is advantageously capable of withstanding or reducing air and thermo-hydric transfers. Indeed, this element has a controlled permeability to transfers of air, of water in the form of vapor or liquid.

Examples of applications of the absorbent concrete material of the invention correspond to the manufacture of slabs for parking areas, for areas with low traffic, the construction of streets in residential areas, pedestrian crossing areas, etc. In other words, the absorbent concrete material of the invention may be used as (part of) concrete slab, (part of) a pavement, (part of) a road, (part of) a road island such as a roundabout, a panel suitable for cladding, or elements of urban furniture such as banks and the like. In such applications, because of its high evapotranspiration capacity, the absorbent concrete material of the invention allows to locally reduce the temperature during heat waves, thus helping in managing climate change impacts on populations.

Thus, the invention further relates to a construction element, for instance a concrete slab, (part of) a pavement, (part of) a road, (part of) a road island such as a roundabout, or (part of) urban furniture such as banks and the like, comprising or consisting of the absorbent concrete material of the invention.

In another aspect, the invention relates to a use of the absorbent concrete material of the invention for removing (at least in part) from the atmosphere gases and volatile compounds including nitrogen oxides, preferably NOx, sulfur oxides, volatile organic compounds, ozone or carbon monoxide, more preferably NOx, even more preferably NO₂.

The invention also relates to a method for depolluting the atmosphere (at least in part), or for withdrawing NOx from the atmosphere (at least in part), comprising trapping, in particular absorbing, atmosphere gases and volatile compounds including nitrogen oxides, and preferably NOx, sulfur oxides, volatile organic compounds and ozone, more preferably NOx, even more preferably NO2, in a building or construction comprising the absorbent concrete material of the invention.

The invention further relates to a method for depolluting the atmosphere (at least in part), or for withdrawing NOx from the atmosphere (at least in part) in a zone to be depolluted, comprising manufacturing a building or a construction located in the zone to be depolluted with the absorbent concrete material of the invention.

### Methods

### Measurement of Absorption Capacity

A cement slurry of the invention is typically cast in a cubic mold of 10 cm*10 cm*10 cm dimensions.

The cement slurry is cured for 28 days at 20° C. and 100% relative humidity to give an absorbent mineral composition. The absorbent mineral composition is then dried at 60° C. until its mass remains constant, i.e., until the mass difference between two measurements measured 24 hours apart, is of 0.5% or less. A dried and cured absorbent mineral composition sample is thus obtained.

The dried and cured absorbent mineral composition sample is fully immersed and maintained under the water surface (where appropriate using weighs so it does not float) into a water tank for one hour. The “wet” absorbent mineral composition sample is then removed and put on a wet tissue to remove excess water, before measuring its mass.

The absorption capacity is expressed as %, and is calculated using the following formula:

AbS_{capacity}=100×(M_{wet}−M_{dried})/M_{dried})

wherein M_{dried} is the mass of the dried and cured absorbent mineral composition, and
M_{wet} is the mass of the “wet” absorbent mineral composition.

### Measurement of Capillarity Absorption

A dried and cured absorbent mineral composition sample is prepared as described previously for absorption capacity.

The dried and cured absorbent mineral composition sample is put in an empty tank, and water is added up to 1 cm height. The dried and cured absorbent mineral composition sample is maintained in water (where appropriate using weighs so the dried and cured absorbent mineral composition sample does not float) for one hour. The “humid” absorbent mineral composition sample is then removed from the tank.

The capillarity absorption is expressed as %, and is calculated using the following formula:

AbS_{capillarity}=100×(M_{humid}−M_{dried})/M_{dried})

wherein M_{dried} is the mass of the dried and cured absorbent mineral composition, and
M_{humid} is the mass of the “humid” absorbent mineral composition.

### Measurement of Evapotranspiration Capacity

Place a sample of absorbent concrete material in an oven at 40° C. until a “dry” reference mass is reached. This drying time is of at least several days in order to obtain a dry sample before a test. The material is then dry when its weight does not vary of more than 1 wt.-% between two consecutive measurements 24 hours apart from each other.

The tray is weighed regularly to monitor its water loss. When no more water loss is observed (the sample mass is sensibly constant), its dry mass is referenced. The mass loss is recorded in real time or at preset intervals using a connected digital weighing machine.

The dry sample is then wet just before starting the test.

There are several “wetting” methods. a first method (adding a known quantity of water) is more representative of “real rainfalls conditions”, while a second method allows to get comparative measurements and identify the maximum evapotranspiration capacity of a given sample. A third method consists in absorbing water by the bottom (using capillary properties) with a constant water level and measuring the water flow rate to maintain the level, which correspond to the evaporation rate.

In order to assess the cooling effect of the material, the temperature is measured with a sensor in the room between the fan and the balance, close to the sample, and also with a sensor a little further away (next to the fan to avoid wind effects). Temperature are also measured above the sample using two additional sensors attached with adhesive paste to a wire. A sensor connected to the thermocouples present within the sample allows to obtain the internal temperature variations (bottom and middle of the sample).

### 1^{st} Wetting Method—Adding a Known Quantity of Water

Once the sample under study is in place with all the functional sensors as well as the devices simulating the real conditions ready to be launched, weigh a desired mass of water (e.g. 200 g) in a beaker using a precision balance. Pour the weighed amount of water over the entire surface of the sample as evenly as possible. Start the acquisition of the balance just after the addition of water. Finally, start the fan on speed 1 and connect the projector.

### 2^{nd} Wetting Method—Saturation

After being dried, the sample is taken to a 100% relative humidity (RH) room in the basement and then immersed in a tank filled with water. The immersion time is of 5 minutes. At the end of this immersion time, the sample is taken out of the tank and placed upside down on a grid in the 100% RH room and a drainage phase begins. The drainage duration is of 5 hours.

### Measurement of Open Porosity

The open porosity of the material is measured by mercury intrusion using a penetrometer. Low and high pressures are applied for mercury to penetrate into the material. The volume of mercury that penetrates into the sample at the end of the experiment must be between 25% and 90% of the penetrometer.

The measurement of open porosity is related to the Washburn equation (1) which relates the pressure applied to the pore diameter:

$$D = - ( 1 / P ) 4 ( γ ) cos ( θ ) \qquad ( 1 )$$

wherein D is the pore diameter, P is the pressure applied, γ is the surface tension of mercury (0.485 N/m) and θ is the contact angle of mercury (130°) Mercury is used because it has a high contact angle (it is a non-wetting liquid). The volume of penetrated mercury is measured as a function of the pressure applied to the material. Washburn's equation relates pressure to pore diameter. This diameter corresponds to the entrance diameter of the pore.

Standard DIN ISO 15901-1 of March 2019 provides a full description of the measurement method of open porosity.

### Measurement of Setting Time

The setting time is measured according to the standard NF EN 196-3 published in January 2009.

### Measurement of the Yield Stress of the Absorbent Mineral Composition

The yield stress represents the minimum of shear stress to be applied to the material before flowing. It is measured with a 4-cross blade, known as a vane. The yield stress is a function of the vane diameter (D) and height (H) and the vane is rotated at a low velocity so that the maximum torque doesn't depend on the viscosity.

The vane has a diameter of 40 mm, and a height of 55 mm, the velocity is 0.1 rpm.

The measurement begins 1 minute after the introduction of the blade in the material. The maximum value of the stress is then reported and considered as the static yield stress.

### Method for Measuring the Compressive Strength (CS) of the Absorbent Mineral Composition:

A cement slurry of the invention is typically cast in a mold. The cement slurry is cured for 28 days at 20° C. and 100% relative humidity to give a cured absorbent mineral composition. Cubic samples (dimensions 4 cm*4 cm*4 cm) are used for measuring the compressive strength.

A mini press is used for measuring low resistances, which are measured according to the standard NF EN 826 of May 2013.

### Adsorption Test Method:

NOx gas adsorption tests were performed using a fused quartz reactor (3.8 dm3). The gas was injected into the reactor via 5 holes to homogenize the flow pattern. The NO/NO2 concentration inlet (respectively 768 μg/m³ NO and 478 μg/m³ NO2) and outlet streams were controlled with an automatic NOx gas analyser (AC32M from Environnement SA, France). The mixed two gases were injected via a nitrogen carrier, with controlled relative humidity (45%). The instantaneous percentage reduction in pollutant gas concentration is expressed as AEₚₒₗₗᵤₜₐₙₜ=[(C0−Csample)/Cinlet)*100], wherein:

AEₚₒₗₗᵤₜₐₙₜ stands for “adsorption efficiency” for pollutant (NO or NO2).

C0 and Csample are the simultaneous concentrations of the pollutant, at the outlet of the bypass and of the reactor containing the solid sample, respectively.

Samples were exposed in the chamber over a period of 24 hours. The size of the samples is 15 cm*15 cm*5 cm with only the top surface exposed to the pollutants stream (all other surfaces are blocked with sealer).

The performance can also be expressed as a percentage by summing/integrating the instantaneous mitigation value over twenty four hours.

### DESCRIPTION OF THE FIGURES

FIG. 1 shows the evaporation rate (in mm/h) over time (in h) of two samples subjected to the evapotranspiration test using wetting method. The diamonds are the values measures with porous concrete alone and the circles are those measured for the sample according to the invention.

FIG. 2 shows the NO₂ mitigation performance for the materials tested in example 2. The vertical axis corresponds to the ratio [NO₂]/[NO₂] inlet. The horizontal axis corresponds to the time (in h).

### EXAMPLES

### Example 1

### Materials

The cement used is a CEM I 52.5 N supplied by the Lafarge plant of Val d'Azergues in France.

The viscosity-modifying agent (VMA) is Kelcocrete DG (DG stands for diutan gum) supplied by BASF as a powder.

The accelerator is Denka SC1 (calcium aluminate-based accelerator) supplied by Denka as a powder.

Water: tap water

The porous concrete: is prepared according to the following compositions:

TABLE 1

| | |
|---|---|
| CEM I 52.5N | 280 kg/m³ |
| Gravel-3/6 mm from Cassis Lafarge quarry | 1489 kg/m³ |
| Admixture-MAPEI Mapecrete Drain P | 0.75 kg/m³ |
| Water | 87.5 L/m³ |

### Equipment

### The Rayneri Mixer:

A Turbotest mixer supplied by the company Rayneri, which is a mixer with a vertical axis equipped with a deflocculating blade.

### For the Evapotranspiration Test:

1 connected weighing machine to measure the mass loss continuously during the whole test
1 fan to simulate the effects of wind sweeping the sample
1 projector fixed above the sample to simulate solar radiation (80 W or ~1000 W/m² equivalent sunlight at zenith)
1 Testo sensor to measure the temperature and humidity near the sample
1 Testo sensor to measure the temperature inside the sample
1 iButton reference sensor outside the range of the fan to measure the temperature and humidity of the room
2 iButton sensors above the sample to measure temperature and near sample humidity

### Preparation of the Absorbent Cement Slurries

For preparing one liter of slurry, the following compositions were used:

TABLE 2

| | Accelerator/Cement | VMA | VMA/Cement | |
|---|---|---|---|---|
| MIX | (in wt.-%) | (g) | ratio (in %) | W/C |
| 1 | — | 3 | 0.2% | 2 |
| 2 | — | 3 | 0.3% | 3 |
| 3 | — | 4 | 0.4% | 4 |
| 4 | 5% | 3 | 0.21% | 2 |
| 5 | 5% | 3 | 0.32% | 3 |
| 6 | 5% | 4 | 0.42% | 4 |

All six cement slurries were prepared using a mixer Rayneri Turbotest 33/300 equipped with a deflocculating blade, into which tap water was first introduced.

Then, while mixing at 300 rpm, the VMA (diutan gum) was added. The aqueous solution was continuously stirred until having a yield stress value between 0.1 and 1.0 Pa.

While mixing at 600 rpm, the solid components were progressively added, preferably over 1 minute. The cement slurry was then mixed for two additional minutes, until no flocs were visually detectable.

### Preparation of the Porous Concrete

Around 130 L of the porous concrete described in table 1 is poured into the superior cavity of a mold comprising two cavities, to form a slab of porous concrete having the following dimensions: 100×120×2-15 cm. The first (superior) cavity has the following dimensions: 100×120×18 cm thickness, said mold being covered with geotextile. Below the first cavity is the second cavity. The second (inferior) cavity has the following dimensions: 1.2 m² exposed surface and 5 cm thickness. The second cavity is filled with gravel. A faucet is adapted into the wall of the second cavity 1 cm from its lower surface to drain the second cavity when appropriate.

To prepare the absorbent concrete material, around 28 L of absorbent cement slurry is then poured onto the sample of the porous concrete, until the slurry reaches the level of the porous concrete. The slurry is then left to set within the porous concrete at a temperature of 20° C. for 7 days.

The slurry is then left to set within the porous concrete at a temperature of 20° C. for 7 days. The surface exposed to the simulated “wind” is thus of 1.2 m².

### Results

The sample of absorbent concrete material is prepared according to the method described above and the evapotranspiration is measured according to the method described above.

The results obtained in a laboratory environment with constant humidity and temperature conditions are presented in table 3 below.

The results show that the absorbent concrete material obtained with mix 2 has a high evaporation rate, which is actually higher than a surface of soil and grass. The effect measured measured by mix 2 is transposable to mixes 1 to 6, which are all according to the present invention.

TABLE 3

| | | | Compressive | Absorption | Capillary | Evaporation |
|---|---|---|---|---|---|---|
| | | | strength at | capacity | absorption | rate |
| MIX | Description | W/C ratio | 28 days (MPa) | (wt.-%) | (wt.-%) | (mm/day) |
| 1 | E/C 2 | 2 | 1.08 | 90 | 91.0 | N.M. |
| 2 | E/C 3 | 3 | 0.21 | 154 | 142 | 6.0 |
| 3 | E/C 4 | 4 | <0.05 | 209 | 207 | N.M. |
| 4 | E/C 2 + accelerator | 2 | 1.03 | 100 | 96 | N.M. |
| 5 | E/C 3 + accelerator | 3 | 0.35 | 154 | 128 | N.M. |
| 6 | E/C 4 + accelerator | 4 | 0.25 | 196 | 158 | N.M. |
| Ref 1 | Lawn | N.A. | N.A. | N.A. | N.A. | 1.95 |
| Ref 2 | Soil + grass | N.A. | N.A. | N.A. | N.A. | 5.35 |
| Ref 3 | Hydromedia with | N.A. | N.A. | N.A. | N.A. | 1.5 |
| | conventional | | | | | |
| | aggregates | | | | | |
| Ref 4 | Hydromedia with | N.A. | N.A. | N.A. | N.A. | 2.2 |
| | recycled aggregates | | | | | |
| | water | | | | | 10 |

N.M.: value not measured.
N.A.: not applicable

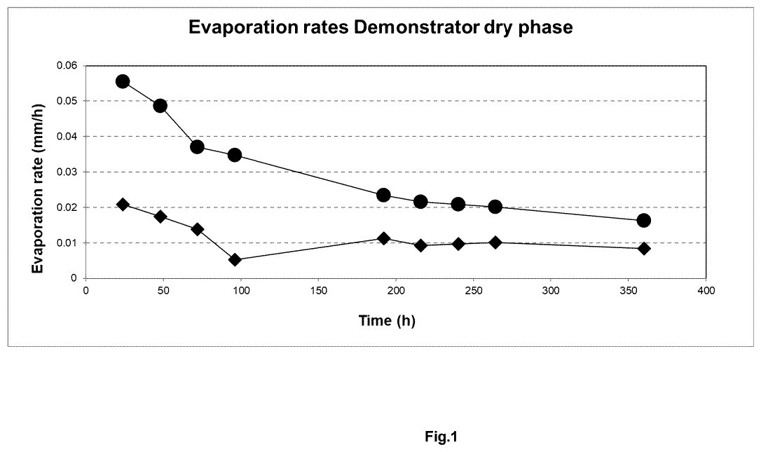

Other tests were performed outdoors over the summer of 2022 in a private area non accessible to the public. The samples were thus subjected to real external conditions. The temperature ranged from 18.0° C. to 30.6° C. A first dry episode of 16 days (referred to as “the dry phase”) was followed by around 10 days of rain showers. The second dry episode following the rain showers is referred to as “the wet phase”. FIG. 1 shows the evaporation rate measured over a period of 400 h during the “dry phase” and demonstrates that the material according to the invention has a higher evaporation rate that pervious concrete alone.

As compared with a conventional porous concrete, the absorbent concrete material of the invention has an evapotranspiration capacity increased by around 2.0 to 4.0, and typically of around 2.5-3.0. The same tendency is observed in the lab tests and in the real condition (outdoors) tests.

In the real condition (outdoors) tests, it was shown that the surface temperature of the absorbent concrete material is lowered by 2° C. to 10° C., as compared with a conventional porous concrete, depending on the external temperature (and hour of the day).

### Example 2

### Materials

The cement used is a CEM I 52.5 N supplied by the Lafarge plant of Val d'Azergues in France.

The viscosity-modifying agent (VMA) is Kelcocrete DG (DG stands for diutan gum) supplied by BASF as a powder.

Water: tap water

The porous concrete PC-0 is prepared according to the compositions of table 4:

TABLE 4

| CEM I 52.5N | 280 kg/m³ |
|---|---|
| Gravel-3/6 mm from Cassis Lafarge quarry | 1480 kg/m³ |
| Admixture-MAPEI Mapecrete Drain P | 0.75 kg/m³ |
| W/C | 0.36 |

The porous concrete PC-0 is prepared following the procedure set forth in example 1.

The absorbent cement slurry 7 (or RIMS-0) is prepared using the composition of table 5:

TABLE 5

| | Accelerator/Cement | VMA | VMA/Cement | |
|---|---|---|---|---|
| MIX | (in wt.-%) | (g) | ratio (in %) | W/C |
| 7 (RIMS-0) | — | 3 | 0.3% | 3 |

Table 5

The absorbent cement slurry RIMS-0 and absorbent concrete material (hereinafter PC-RIMS-0) are prepared using the same procedures as in example 1.

### Results

The porous concrete PC-0, absorbent cement slurry RIMS-0 and absorbent concrete material PC-RIMS-0 were tested for NO₂ adsorption efficiency using the adsorption test method described above.

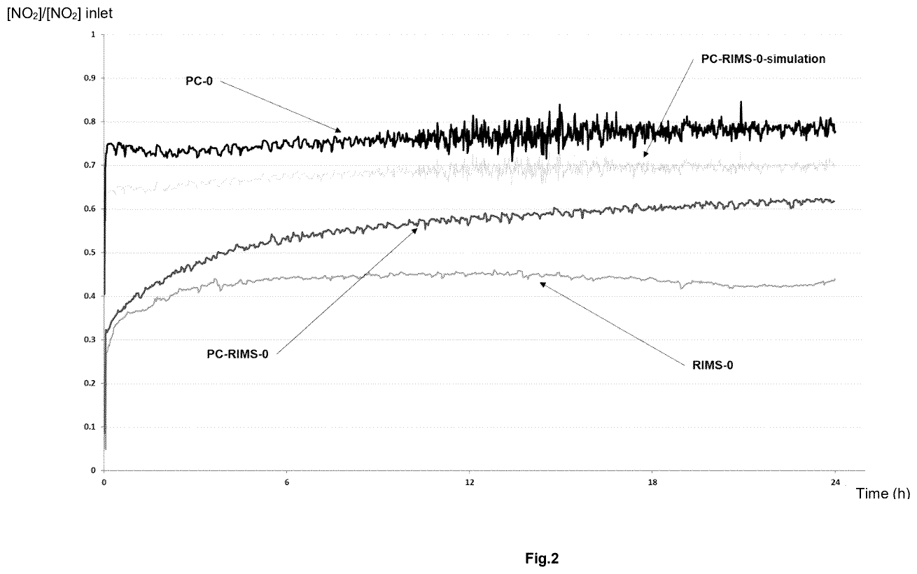

The results are shown in FIG. 2 and in table 6 below.

TABLE 6

| | Open Porosity | AE_{(NO2)} |
|---|---|---|
| PC-0 | 21% | 24% |
| RIMS-0 | 70% | 57% |
| PC-RIMS-0 | n. m. | 44% |
| Simulated results for PC-RIMS | N/A | 35% |

N.M.: value not measured.
N.A.: not applicable

The NO₂ adsorption efficiency of the absorbent concrete material PC-RIMS-0 is compared to the NO₂ adsorption efficiency which would be expected from an absorbent concrete material wherein the contribution to NO₂ adsorption is of each of the pervious concrete and the absorbent cement slurry would be related to its volume ratio in the absorbent concrete material.

To this end, a simulated result (called simulated result for PC-RIMS in table 6) is calculated using the following formula:

[simulatedAE]^{NO2}=vol^{PC-0}*[AE_PC-0]_{NO2}+vol^{RIMS-0}*[AE_RIMS-0]_{NO2}

with vol^{PC-0}=76% and vol^{RIMS-0}=24%, [AE_PC-0]_{NO2} and [AE_RIMS-0]_{NO2} values being as in table 6.

As can be seen from table 6, the NO₂ adsorption efficiency which is actually measured for the absorbent concrete material PC-RIMS-0 is significantly higher than that obtained from a mere cumulative result of the individual components. This comparison demonstrates that there is a synergistic effect obtained with regards to NO2 mitigation when the absorbent concrete material is used.

1. An absorbent concrete material comprising a porous concrete with an open porosity ranging from 15% to 40%, expressed as a volume percentage of the porous concrete, said porous concrete comprising interconnected pores at least partially filled with an absorbent mineral composition, said absorbent mineral composition comprising 90 wt.-% or more, relative to a total weight of the absorbent mineral composition in a dry state, of:
cement comprising up to 10 wt.-% of calcium aluminate cements, calcium sulfoaluminate cements, or mixtures thereof, relative to the total weight of cement, and
a viscosity modifying agent.

2. (canceled)

3. The absorbent concrete material of claim 1, wherein, in the absorbent mineral composition, the cement comprises mineral selected from the group consisting of calcium carbonate, silica, ground glass, solid or hollow glass beads, glass granules, expanded glass powders, silica aerogels, silica fume, slags, ground sedimentary siliceous sands, fly ash, calcined clays, pozzolanic materials, concrete demolition waste, ground construction demolition waste, or mixtures thereof.

4. The absorbent concrete material of claim 1, wherein, in the absorbent mineral composition, the viscosity-modifying agent comprises or consists of cellulosic ethers, xanthan gum, or a polymer derived from xanthan gum.

5. The absorbent concrete material of claim 1, wherein, in the absorbent mineral composition, the viscosity-modifying agent/cement mass ratio ranges from 0.1 to 0.8.

6. The absorbent concrete material of claim 1, wherein the absorbent mineral composition comprises up to 5% by weight of additives selected from the group consisting of a water reducer, an accelerator, a superabsorbent polymer, a pigment, and mixtures thereof, relative to the total weight of to the weight of cement.

7. The absorbent concrete material of claim 6, wherein, the absorbent mineral composition comprises a white pigment, and/or a superplasticizer.

8. The absorbent concrete material of claim 1, wherein the absorbent mineral composition comprises 98 wt.-% or more of cement and viscosity-modifying agent relative to the total weight of the absorbent mineral composition.

9. The absorbent concrete material of claim 1, wherein the porous concrete has an open porosity ranging from 25% to 35%, expressed as volume percentages of the porous concrete.

10. A process for improving evapotranspiration of construction elements, or as an insulating material, the process comprising:
providing the absorbent concrete material of claim 1 in a construction element.

11. The process of claim 10, wherein the construction element is a concrete slab, a pavement, a road, a road island, a panel suitable for cladding, or an element of urban furniture.

12. A process for removing, at least in part, from the atmosphere, gases and volatile compounds, the process comprising:
trapping the gases and volatile compounds in the absorbent concrete material of claim 1, wherein the absorbent concrete material is part of a building or construction.

13. A process for preparing an absorbent concrete material, comprising:
a) Providing a porous concrete with an open porosity of 15% or more expressed as a volume percentage of the porous concrete, said porous concrete comprising interconnected pores,
b) Providing an absorbent cement slurry comprising:
cement,
water, and
a viscosity modifying agent,
with a water/cement mass ratio ranging from 2 to 5, and
c) Casting the absorbent cement slurry within the porous concrete so as to fill at least partially the pores with the cement slurry, and letting it set.

14. The process of claim 13, wherein the porous concrete of step (a) is a precast element or is cast in place.

15. The absorbent concrete material of claim 1, wherein the absorbent concrete material comprising a porous concrete with an open porosity ranging from 25 to 35%, expressed as a volume percentage of the porous concrete, and said absorbent mineral composition comprising 95 wt. % or more, relative to the total weight of the absorbent mineral composition in the dry state, of:
cement comprising up to 10 wt.-% of calcium aluminate cements, calcium sulfoaluminate cements, or mixtures thereof, relative to the total weight of cement, and
a viscosity modifying agent.

16. The absorbent concrete material of claim 4, wherein the polymer derived from xanthan gum is diutan gum.

17. The absorbent concrete material of claim 5, wherein the viscosity-modifying agent/cement mass ratio ranges from 0.1 to 0.5.

18. The process of claim 13, comprising 0.01 to 0.5% of the viscosity modifying agent.

19. The process of claim 18, wherein the viscosity-modifying agent/cement mass ratio ranges from 0.1 to 0.8.

20. The process of claim 19, wherein in the absorbent cement slurry, the viscosity-modifying agent/cement mass ratio ranges from 0.1 to 0.5.

21. The process of claim 13, wherein the water/cement mass ratio ranges from 2 to 4.
